(19) United States
(12) Patent Application Publication
(10) Pub. No.: US 2016/0214536 A1
(43) Pub. Date: Jul. 28, 2016

(54) Door-Mounted Side View Camera System For A Vehicle

(71) Applicant: Glenn S. Burdge, Stuart, FL (US)

(72) Inventor: Glenn S. Burdge, Stuart, FL (US)

(21) Appl. No.: 14/805,053

(22) Filed: Jul. 21, 2015

Related U.S. Application Data
(60) Provisional application No. 62/107,325, filed on Jan. 23, 2015.

(51) Int. Cl. B60R 1/00; B60R 1/12; G06K 9/00; H04N 7/18; H04N 5/232

(52) U.S. Cl. CPC B60R 1/007; H04N 7/181; H04N 5/23238; G06K 9/00791; B60R 1/12; H04N 2101/00

(57) ABSTRACT

A door-mounted side view camera system for use with a vehicle having an interior cabin and a pair of side doors selectively providing access to the interior cabin includes a first video camera mounted to an exterior surface of one of the side doors, the first video camera being directed rearwardly of the vehicle and configured to capture video footage when energized. The side view camera system includes a first visual display positioned in the interior cabin of the vehicle and in data communication with the first video camera, the first video camera configured to display the video footage captured by the first video camera. In an embodiment, the side view camera includes a second side view camera mounted proximate the other side door and a second visual display mounted to a dashboard within the interior cabin of the vehicle.

### REFERENCE TO RELATED APPLICATIONS

This non-provisional patent application claims the benefit of provisional application Ser. No. 62/107,325 filed on 23 Jan. 2015, titled Door-Mounted Side View Cameras For A Vehicle, which is incorporated herein in its entirety.

### BACKGROUND OF THE INVENTION

This invention relates generally to vehicle equipment and accessories and, more particularly, to a door-mounted side view camera system for an automobile.

Rear view mirrors, mounted on the doors and windshield of a vehicle, are very useful to the driver when maneuvering the vehicle, particularly when backing up or changing lanes. Properly adjusted rear view mirrors enable a driver to see the position of vehicles to the side or rear of the vehicle. Unfortunately, minors often include blind spots in which a vehicle or obstacle to the rear or side of the vehicle is not visible to the driver. Blind spots are virtually unavoidable and can result in accidents.

As a supplement to traditional rear view mirrors, a rear view camera is sometimes mounted immediately above the rear license plate on some models of vehicles. The rear view camera may eliminate one important blind spot—directly behind the vehicle—does not eliminate the others.

Therefore, it would be desirable to have a door-mounted rear view cameras for a vehicle, which replace door-mounted mirrors, eliminate blind spots, and provides video feeds to visual displays located on the dashboard.

### SUMMARY OF THE INVENTION

A door-mounted side view camera system according to the present invention for use with a vehicle having an interior cabin and a pair of side doors selectively providing access to the interior cabin includes a first video camera mounted to an exterior surface of one of the side doors, the first video camera being directed rearwardly of the vehicle and configured to capture video footage when energized. The side view camera system includes a first visual display positioned in the interior cabin of the vehicle and in data communication with the first video camera, the first video camera configured to display the video footage captured by the first video camera. In an embodiment, the side view camera includes a second side view camera mounted proximate the other side door and a second visual display mounted to a dashboard within the interior cabin of the vehicle.

Therefore, a general object of this invention is to provide a door mounted camera system that replaces the traditional side mirrors of a vehicle with wide angle video cameras.

Another object of this invention is to provide a door mounted camera system, as aforesaid, having a visual display situated in the interior cabin of a vehicle and in data communication with a respective camera.

Still another object of this invention is to provide a door mounted camera system, as aforesaid, that enables a driver to view objects located rearward of each side of the vehicle in real time video feeds positioned on the vehicle dashboard.

Yet another object of this invention is to provide a door mounted camera system, as aforesaid, that minimizes or eliminates blind spots characteristic of traditional rear view minors.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a door-mounted side view camera system according to a preferred embodiment of the present invention, illustrated in use on a vehicle;

FIG. 1b is an isolated view on an enlarged scale taken from FIG. 1a;

FIG. 2a is a perspective view of a first video camera and first housing removed from the vehicle;

FIG. 2b is a perspective view of a second video camera and second housing removed from the vehicle;

FIG. 3 is a front view of first and second visual displays mounted to a dashboard of a vehicle;

FIG. 4a is a front view of the first visual display as an aftermarket accessory;

FIG. 4b is a rear view of the first visual display as an aftermarket accessory; and

FIG. 5 is a block diagram illustrating the electrical components of the present system.

### DESCRIPTION OF THE PREFERRED EMBODIMENT

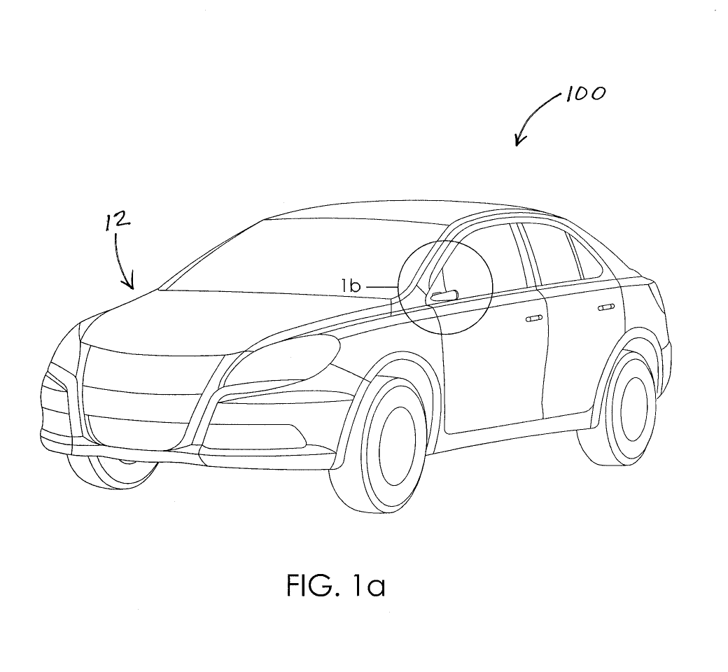

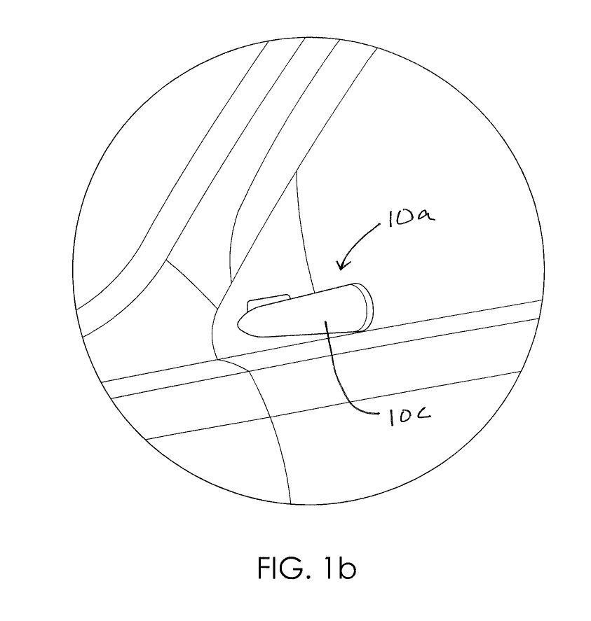

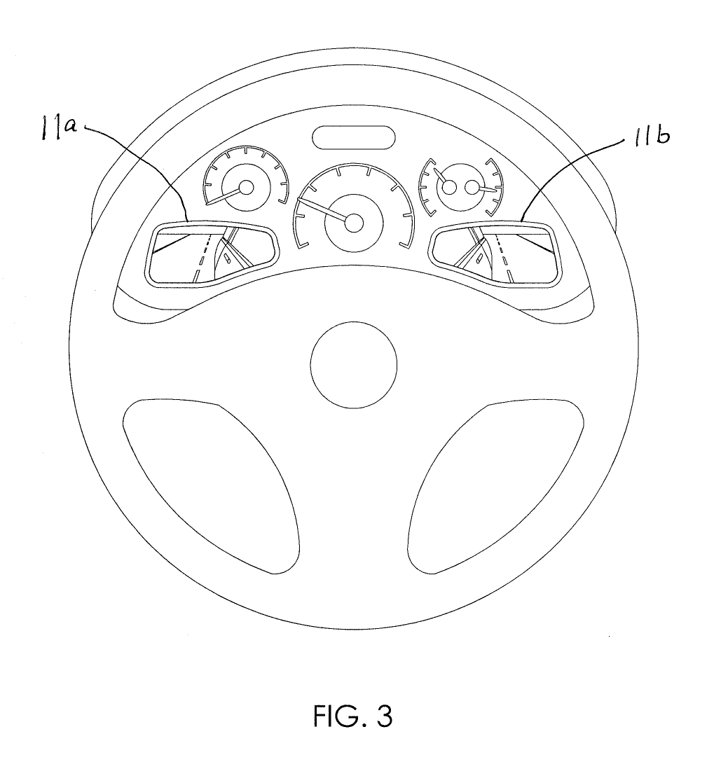

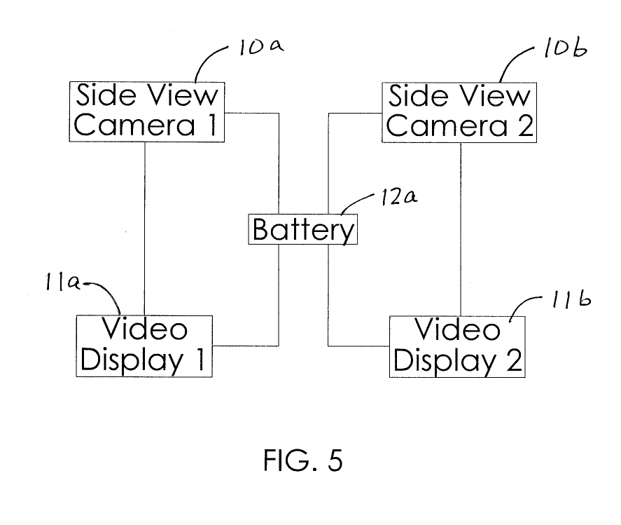

A door-mounted side view camera system according to a preferred embodiment of the present invention will now be described in detail with reference to FIGS. 1 to 5 of the accompanying drawings. The door-mounted side view camera system 100 includes a pair of video cameras 10a, 10b and at least a first visual display 11a.

The first exemplary embodiment is intended for installation as original equipment by the manufacturer of the vehicle 12. An alternate embodiment, which is intended for installation as an after-market modification by the owner of the vehicle, or by a repair or customizing shop, is contemplated. The cameras of the alternate embodiment would be mounted with adhesive, suction cups, brackets, or some other mechanical means.

The first exemplary embodiment includes two video cameras in respective aerodynamic housings, which replace the door-mounted rear view minors and provide the user with greater viewing area than the minors, for example with enhanced side view. The video feeds of the cameras are transmitted and displayed on visual displays 11a, 11b on the dashboard 13 of the vehicle 12.

Now, more particularly, the first video camera 10a is situated in a first housing 10c that is mounted to one of the front doors of the vehicle 12. Preferably, the first housing 10c is connected to the door adjacent a lower front region of the door's window frame. The first housing 10c is situated such that the first video camera 10a is directed rearwardly of the vehicle 12, i.e. to view cars or other obstacles rearward of the vehicle 12. It is understood that the first video camera 10a essentially replaces the traditional side rear view minor of the vehicle 12.

The first housing 10c may include a slender, elongate configuration that is more streamlined and aerodynamic when the vehicle 12 is moving than the side mirrors they replace. In addition, the cameras 10 preferably include wide angle lenses having a broader field of vision, including peripheral side view, than is provided by traditional door-mounted rear view mirrors.

A second video camera 10b may be situated in a second housing 10d that is mounted to another of the front doors of the vehicle 12. The second housing 10d has a configuration substantially similar to that of the first housing 10c described above and is mounted in the same manner.

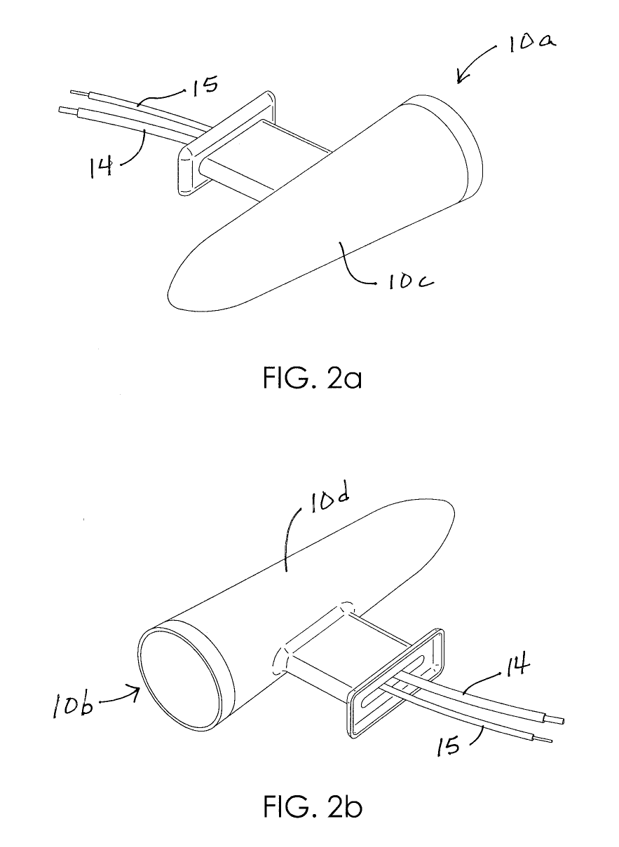

Each video camera may include a power cable 14 and a video feed cable 15 (FIGS. 2a and 2b). The power cable 14 is configured to connect to the power system of the vehicle 12, such as directly or indirectly to the vehicle battery. The video feed cable 15 may be in data communication with first and second visual displays as will be described below.

More particularly, the door-mounted side view camera system 100 includes a first visual display 11a mounted in the interior cabin of the vehicle 12. The first visual display 11a is in data communication with the first video camera 10a with the video feed cable 15 and configured to display the video feed showing objects rearward of the vehicle. In an embodiment, the data connection may be via a wireless connection, such as with a transmitter/receiver combination.

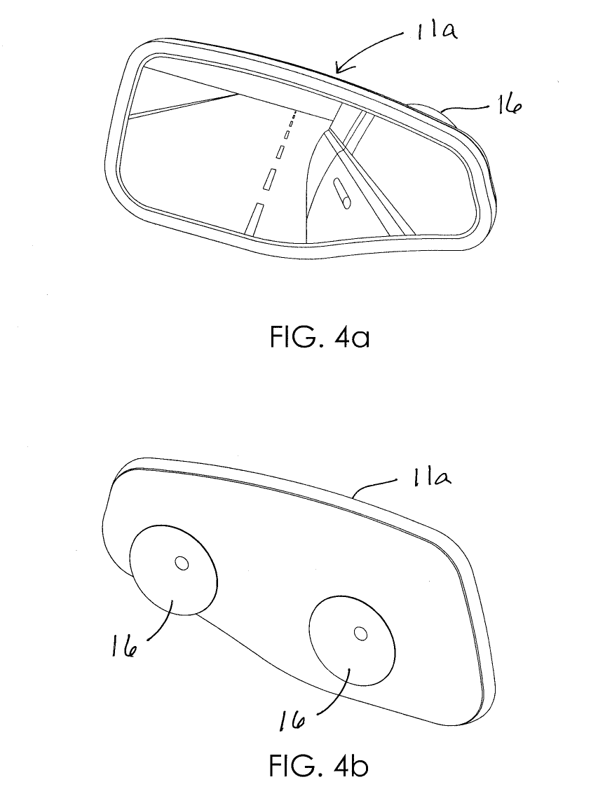

Similarly, a second visual display 11b may be mounted in the interior cabin of the vehicle adjacent the first visual display 11a. The second visual display 11b is in data communication with the second video camera 10b with the video feed cable 15 and configured to display the real time video feed showing objects rearward of the vehicle. In an embodiment, the data connection may be via a wireless connection, such as with a transmitter/receiver combination. In an embodiment, both the first visual display 11a and the second visual display 11b are integrated into the driver's display panel portion of the dashboard, e.g. along with the speedometer, tachometer, and other vehicle sensory data. In another embodiment of the present invention, the visual displays may be positioned in the cabin of the vehicle as an aftermarket accessory. For instance, the visual displays may be mounted with adhesive, suction cups 16, brackets, or some other mechanical means (FIGS. 4a and 4b).

In use, the user starts the engine of the vehicle 12 and may check the video feeds from the cameras 10 at any time, by viewing the visual displays 11a, 11b on the dashboard 13. The visual displays will show objects rearward of either side of the vehicle 12 in real time and minimize blind spots that are characteristic of traditional side rear view mirrors.

The cameras 10 and the visual displays 11a, 11b are preferably manufactured from rigid, durable materials such as plastic, steel, aluminum alloy, copper alloy, acrylic polymer, and brass. The lenses 10A are preferably manufactured from a rigid, durable material which is transparent, such as glass. The cables are preferably manufactured from copper alloy wire sheathed in plastic.

It is understood that while certain forms of this invention have been illustrated and described, it is not limited thereto except insofar as such limitations are included in the following claims and allowable functional equivalents thereof.

1. A door-mounted side view camera system for use with a vehicle having an interior cabin and a pair of side doors selectively providing access to the interior cabin, comprising:
a first video camera mounted to an exterior surface of one of the side doors, said first video camera being directed rearwardly of the vehicle and configured to capture video footage when energized; and
a first visual display positioned in the interior cabin of the vehicle and in data communication with said first video camera, said first video camera configured to display said video footage captured by said first video camera.

2. The camera system as in claim 1, wherein said first video camera is mounted to said one of the side doors in lieu of a traditional side view minor.

3. The camera system as in claim 2, wherein said first video camera is positioned adjacent a lower front area of a window frame of a side door.

4. The camera system as in claim 1, wherein said first video camera is in data communication with said first visual display via a wireless data connection.

5. The camera system as in claim 1, wherein said first video camera is in data communication with said first visual display via a hardwired data connection.

6. The camera system as in claim 1, wherein said first visual display is integrally mounted in a dashboard of the vehicle.

7. The camera system as in claim 1, wherein said first visual display is removably coupled to a dashboard of the vehicle.

8. The camera system as in claim 1, wherein said first video camera and said first visual display are electrically connected to an electric system of the vehicle.

9. The camera system as in claim 1, wherein said first video camera is positioned in a first housing having a slender, elongate configuration that is aerodynamic.

10. The camera system as in claim 1, wherein said first video camera includes a wide angle lens configured to reduce the potential for a blind spot.

11. The camera system as in claim 1, comprising:
a second video camera mounted to an exterior surface of another of the side doors, said second video camera being directed rearwardly of the vehicle and configured to capture video footage when energized; and
a second visual display positioned in the interior cabin of the vehicle and in data communication with said second video camera, said second video camera configured to display said video footage captured by said second video camera.

12. The camera system as in claim 11, wherein said second video camera is mounted to said another of the side doors in lieu of a traditional side view mirror.

13. The camera system as in claim 12, wherein said second video camera is positioned adjacent a lower front area of a window frame of a side door.

14. The camera system as in claim 11, wherein said second video camera is in data communication with said second visual display via a wireless data connection.

15. The camera system as in claim 11, wherein said second video camera is in data communication with said second visual display via a hardwired data connection.

16. The camera system as in claim 11, wherein said second visual display is integrally mounted in a dashboard of the vehicle.

17. The camera system as in claim 11, wherein said second visual display is removably coupled to a dashboard of the vehicle.

18. The camera system as in claim 13, wherein said second video camera and said second visual display are electrically connected to an electric system of the vehicle.

19. The camera system as in claim 18, wherein said second video camera is situated in a second housing having a slender, elongate configuration that is aerodynamic.

20. The camera system as in claim 19, wherein said second video camera includes a wide angle lens that reduces the potential of a blind spot.
